(19) United States
(12) Patent Application Publication
(10) Pub. No.: US 2014/0103234 A1
(43) Pub. Date: Apr. 17, 2014

(54) AIRFLOW REGULATING VALVE ASSEMBLY

(71) Applicants: Fabian Mauricio Barreda, Miami, FL (US); Cassio S. Silva, Fort Lauderdale, FL (US); Juan Carlos Bocos, Sunny Isles Beach, FL (US)

(72) Inventors: Fabian Mauricio Barreda, Miami, FL (US); Cassio S. Silva, Fort Lauderdale, FL (US); Juan Carlos Bocos, Sunny Isles Beach, FL (US)

(21) Appl. No.: 13/888,875

(22) Filed: May 7, 2013

Related U.S. Application Data
(63) Continuation-in-part of application No. 12/383,708, filed on Mar. 27, 2009, now abandoned.
(60) Provisional application No. 61/070,994, filed on Mar. 27, 2008.

(51) Int. Cl. F16K 15/06

(52) U.S. Cl. CPC F16K 15/063
USPC 251/66

(57) ABSTRACT

A valve assembly disposed within a water supply line upstream of a water meter and structured to reduce or significantly eliminate the passage of air through the meter including a housing having an interior channel and a valve body movably disposed within the channel. The valve body includes a sealing structure which is biased, under a predetermined force, into sealing relation with an inlet of the interior channel. The predetermined force is sufficient to prevent displacement of the sealing structure out of the sealing relation with the inlet, but insufficient to prevent displacement of the sealing structure when force from a normal water flow is exerted thereon from within the water supply line. Air flow within the water supply line will be compressed or otherwise be prevented from passing through the meter, thereby preventing unnecessary charges being made to the metered facility.

### CLAIM OF PRIORITY

The present application is a Continuation-In-Part application of previously filed, now pending application having Ser. No. 12/383,708 which was filed on Mar. 27, 2009, which claims priority pursuant to 35 U.S.C. Section 119(e) filed Provisional patent application, having Ser. No. 61/070,994 filed on Mar. 27, 2008, and which is incorporated herein in its entirety by reference.

### BACKGROUND OF THE INVENTION

1. Field of the Invention

This invention relates to a valve assembly disposed along a path of fluid flow along in a conventional water supply line, upstream of a conventional water meter assembly which is disposed and structured to determine the quantity of water delivered to a corresponding facility. The valve assembly is structured to eliminate or significantly reduce the passage of air through the water meter, wherein the air may be in the form of an “air pocket” existing within the water supply line due to damage, repair, or maintenance thereof. As a result the meter will only register the actual quantity of water delivered to the facility and avoid any charges resulting from the passage of air through the meter.

2. Description of the Related Art

Approximately three and one-half billion people throughout the world have access to a water supply delivered to a domestic or commercial facility by a water supply line(s) in the form of pipes, conduits, etc. The origin of the water supply, especially in an urban environment, is typically from a public or regulated water utility which controls the supply, delivery, purification, and/or other processing of the water being delivered. Alternatively, many domestic facilities rely individually or collectively on wells or other underground sources of water which are not under the control a public water utility company. In either situation, it is recognized that water must be delivered to a facility with sufficient pressure to assure an adequate quantity of water being delivered at a sufficient flow rate for use in variety of different applications.

Water pressures may vary at different locations through out a given geographical area and are based in large part upon the structure and/or efficiency of the corresponding distribution system. By way of example, water mains below ground may operate at a higher pressure in order to deliver the water to distribution stations. Moreover, “pressure reducers” or like structures are frequently disposed in the path of water flow at such distribution locations prior to being delivered to the domestic or commercial facility. Accordingly, water may be delivered to a home or other conventional domestic facility having a typical water pressure of generally about 60 psi.

In situations involving the delivery of water along a conventional water supply line to a domestic or commercial facility a metering of the water supply takes place generally at the point of delivery to the domestic or commercial facility. A conventional water meter assembly may vary in both structure and operation but is typically provided to allow water utility companies other or agencies associated therewith to charge for water, based on the amount used. As a result, the metering of water delivered from a water utility company to any facility is widely considered to be an acceptable practice and a fair means of charging for the quantity of water utilized.

The monitoring procedure performed by the water meter being indicative of the quantity of water utilized, is accomplished in numerous ways including, but not limited to, the manual “reading” of the meter and the delivery of the results of the reading to a billing facility associated with the water utility. However, many cities are increasingly installing automatic meter reading systems to prevent fraud and lower the labor cost of manual meter reading. In addition, it is believed that such automatic meter reading systems improve customer service and satisfaction by assuring a more accurate determination of the quantity of water being utilized.

However, as is commonly recognized by individuals connected to public utility distribution facilities, wherein the delivered water is metered to determine the quantity of water utilized, there is an occasional interruption of water supply. Such interruptions may be caused by repair, maintenance, malfunction, etc., and typically results in quantities of air entering into the water supply lines. As a result segments of air flow or “air pockets” travel along the path of water flow within the water supply lines and are delivered to the various facilities connected to the supply lines after first passing through the meter assembly associated therewith. As a result, the occurrence of a breakdown or other occasion where air enters the water supply line(s) causes the resulting air pockets, to be measured by the meter assembly and charged to the corresponding facility as used water. This is due to the fact that most, if not all meter assemblies associated with either domestic or commercial facilities are not structured to distinguish between air flow and water flow passing there through. Accordingly, in situations where air enters the water supply line, the connected facility is charged for water that in fact has not been received due to the fact that the corresponding meter assembly registers the flow of air passing therethrough as conventional water flow.

Accordingly, there is a need in the area of water distribution for an appropriate way of eliminating the passage of air through a water meter assembly associated with either a domestic or commercial facility. As a result any cost or charge to the facility for water which was in fact not received or delivered would be eliminated. Such a proposed structure or assembly should efficiently function to prevent or significantly reduce the passage of “air pockets” or other air flow through the water meter assembly, while not interfering with the regular and intended supply of water delivered by the conventional water supply line. Further, such a proposed structure should include sufficient structural integrity and operative performance which assure a long operative life, while not requiring frequent maintenance, repair or replacement. In addition, such a proposed and preferred assembly should be sufficiently low in initial cost to be economically viable for wide spread use in conventional water supply lines, upstream of the water meter assembly, in a multitude of homes, businesses, etc. which are connected to water delivery systems throughout the world.

### SUMMARY OF THE INVENTION

The present invention is directed to a valve assembly structured to eliminate or significantly reduce “air pockets” or other air flow segments, traveling along and within conventional water supply lines, from passing through a conventional water meter assembly, thereby eliminating erroneous charges for water which was not delivered.

As is well recognized, there are occasional breakdowns, repairs, maintenance procedures, malfunctions, etc., of public water utility facilities and/or other water distribution and supply systems which results in the interruption of water delivery. Such interruptions, while not common, frequently result in air entering the path of fluid flow within the water supply lines. Such interruptive air flow, for purposes of clarity, may hereinafter be referred to as “air pockets” and/or “air flow segments”, it being recognized that such air flow may also contain minimal amounts of water such as entrained water vapor. As such, these air pockets are at least partially separated from the conventional water supply passing through the water supply line(s). Regardless of the degree of separation, the formed air pockets or air flow segments also pass through a water meter assemblies associated with the various facilities to which the supply of water is normally delivered. As a result, the homes, businesses and like facilities connected to the water supply lines are charged for water that was never delivered.

Further, the encroachment of air into a conventional water supply line is a well known phenomenon and evidenced by the opening of a spigot or faucet during or immediately after the interruption of the water supply to the facility. Typically, the presence of air pockets will be apparent by a relatively harsh and frequently loud rush of air from the open spigot or faucet followed by successive “spurts” of water and the eventual passage of the normal water flow, once the water supply line has been returned to normal service.

It is also recognized that in a conventional water supply facility controlled and regulated by a public water utility, water is delivered to most domestic and commercial facilities at a water pressure of generally about 60 psi. In contrast, the encroachment of air into the water supply line is typically delivered to the connected home or other intended facility, as well as to the meter assembly associated therewith, at a much lower pressure of generally about 0.3 kg f/cm2. Therefore, the air pressure of the air pocket or air flow segment is delivered to the water meter assembly at a significantly lower pressure than the water pressure of the supply of water delivered to the corresponding meter assembly. Accordingly, the present invention is directed to the aforementioned valve assembly, which is structured to remove or significantly eliminate the air pocket or air flow segment prior to its passage through the meter assembly. As a result any cost or charges associated with the passage of air through the meter assembly will be avoided, thereby providing a more accurate representation of the quantity of water actually delivered to the facility.

More specifically, the valve assembly of the present invention comprises a valve housing connected to the water supply line upstream of the water meter assembly associated with the home or other facility to which the water is being delivered. Further, the valve housing includes an interior channel which is disposed along and at least partially defines the path of fluid flow of the water supply line. Therefore, the normal supply of water travels along the path of fluid flow and through the interior channel of the valve housing as it passes, through the water meter assembly, into the facility where it is used. Moreover, the interior channel includes both an inlet and outlet disposed in fluid communication therewith. In addition, a valve body is movably disposed within the interior channel and includes a sealing structure which is forced, through the provision of a biasing assembly, into sealing engagement or relation with the inlet of the interior channel. The sealing structure and the various components associated therewith, when disposed in sealing relation to the inlet, prevents fluid flow from passing into the interior channel or through the housing and also prevents fluid flow from reaching and passing through the metering assembly associated with the facility to which the water flow is intended to be delivered.

The biasing assembly is disposed within the interior channel in biasing relation with the sealing structure and is disposed and structured to exert a “predetermined force” or “predetermined biasing force” on the sealing structure. This predetermined biasing force is calculated to effectively “recognize” and/or respond to the difference in pressures exerted on the sealing structure, through the inlet, by the water or air existing within the water supply line. More specifically, the predetermined biasing force exerted on the sealing structure is sufficient to force it into sealing relation with the inlet. Therefore, the sealing structure will be displaced from its sealing relation with the inlet, only when the pressure exerted thereon from within the water supply line exceeds the predetermined biasing force. As set forth above, the water pressure passing along a conventional water supply line may typically be in the range of 60 psi. Accordingly, when water having a predetermined water pressure of, by way of example only, 60 psi is exerted on the sealing structure from within the water supply line, it will exceed the predetermined biasing force and the sealing structure will be displaced from its sealing relation with the inlet. Water will then flow through the interior channel of the valve housing and through the water meter. It is emphasized that the predetermined biasing force may vary or be adjusted by a structuring of the biasing assembly to accommodate the actual water pressure of the normal flow of water passing along the water supply line and is not limited to a water pressure of 60 psi, as represented above by way of example only.

In contrast, an air pocket or like air flow segment passing along the water supply line will exert an insufficient amount of air pressure on the sealing structure to displace it from its sealing relation with the inlet. More specifically, the predetermined force or predetermined biasing force exerted on the sealing structure by the biasing assembly from within the interior of the housing is calculated to be greater than any force exerted on the sealing structure from within the water supply line by an air pocket passing along and reaching the inlet of the valve assembly. As a result, the sealing structure will not be displaced from its sealing relation with the inlet and the air pocket will be compressed, resulting in it being disbursed or it being forced into the water in the water supply line being delivered to the facility. As a result air flow will not independently pass through the metering assembly and no inaccurate costs or charges will be registered.

Other features of one or more preferred embodiments of the valve assembly of the present invention includes a retaining structure also disposed within the housing of the valve assembly in retaining engagement with the biasing assembly. As such, the biasing assembly is preferably disposed in biasing engagement with the sealing structure and in a retaining relation with the retaining structure. Also, the retaining structure includes an apertured construction which allows water, once entering into the interior channel of the valve housing, to pass therethrough and eventually through the metering assembly for delivery to the facility associated therewith. Yet additional structural and operative feature include a stabilizing assembly which maintains an accurate, aligned orientation of the valve body and the sealing structure relative to the inlet of the interior channel. As such, the sealing structure is accurately and reliably disposed into and out of sealing relation with the inlet when an appropriate amount of exterior force is exerted thereon from within the water supply line, such as by conventional water flow along the water supply line.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a perspective view of a preferred embodiment of the valve assembly of the present invention.

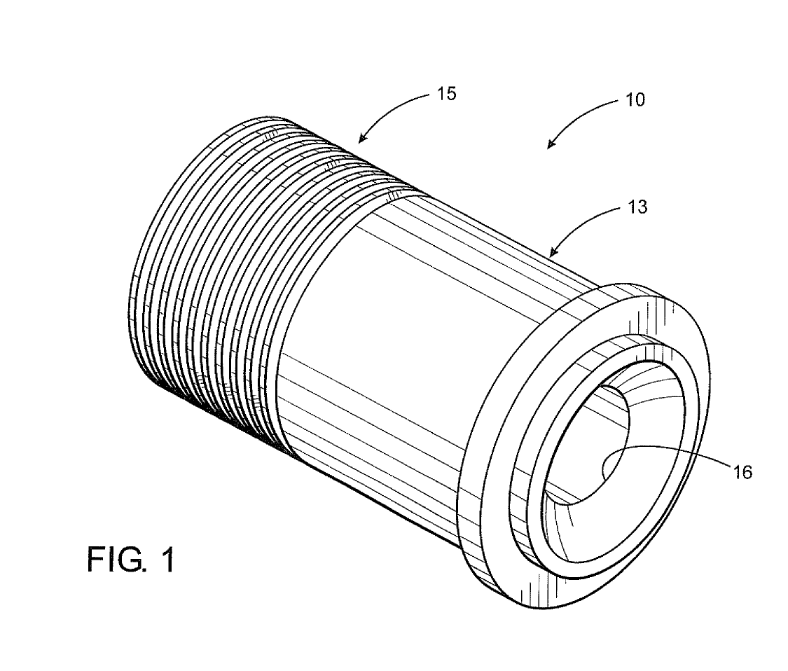

FIG. 2 is a schematic representation of an installation of the valve assembly of the embodiment of FIG. 1.

FIG. 3 is a perspective, sectional, interior view of the housing of the valve assembly of the embodiment of FIG. 1.

FIG. 4 is a detailed perspective view of a valve body associated with the embodiments of FIGS. 1 and 3.

FIG. 5 is a perspective sectional interior view of the valve assembly of the embodiment of FIGS. 1, 3 and 4, in an assembled form.

FIG. 6 is a plan sectional view of the embodiment of FIG. 5.

Like reference numerals refer to like parts throughout the several views of the drawings.

### DETAILED DESCRIPTION OF THE PREFERRED EMBODIMENT

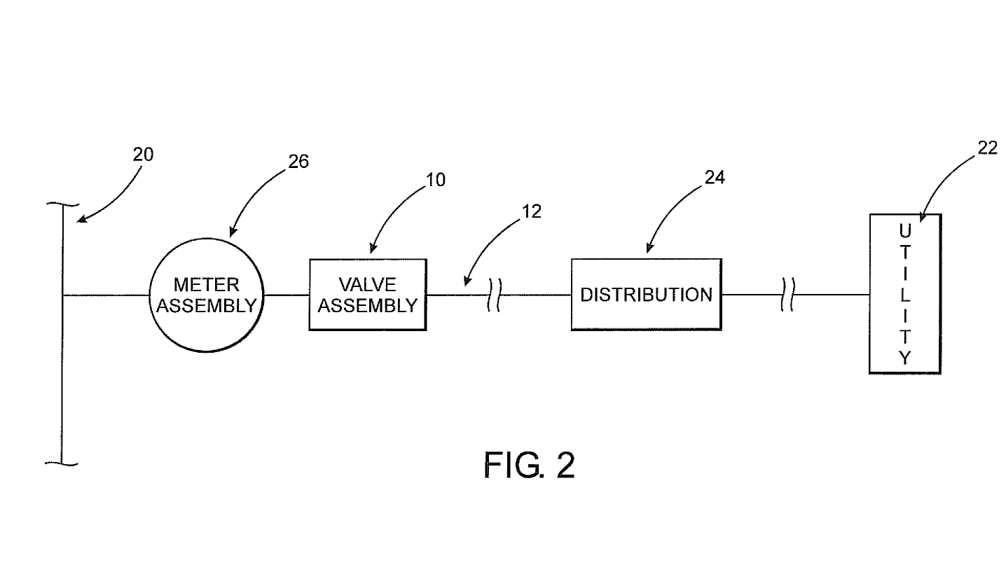

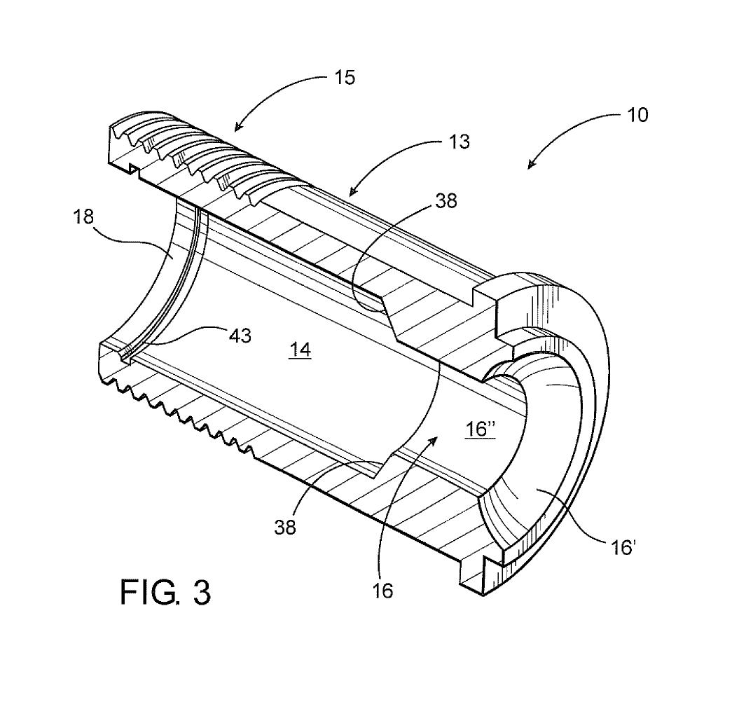

As represented in the accompanying Figures, the present invention is directed to a valve assembly generally indicated as 10 structured to remove or significantly reduce an “air pocket” or an “air flow segment” traveling along a water supply line, generally indicated as 12, as schematically represented in FIG. 2. The valve assembly 10 is connected to the water supply line 12 so as to communicate with and at least partially define a path of fluid flow there along. As such, the valve assembly 10 includes an interior channel 14 having an inlet 16 and an outlet 18, as clearly represented in FIG. 3. As is well known, a number of domestic or commercial facilities, generally indicated as 20, receive water from a conventional water supply line 12. The supply of water may originate at a purification facility, generally indicated as 22, which may be associated with or controlled by a public water works. After processing, the conventional or normal supply of water is delivered along the water supply line(s) 12 to a plurality of distribution stations 24 which may be located a significant distance from the plurality of domestic or commercial facilities 20 to which water is eventually delivered.

Accordingly, the valve assembly 10 of the present invention is connected to and located along the water supply line 12 upstream of a water meter assembly 26 which is associated with the facility 29 to which the water is delivered. As such, water flowing through the meter assembly 26 is measured and the quantity of water utilized and/or delivered to the facility 20 is charged an appropriate rate based on readings or other determinations provided by the meter assembly 26. Therefore, in order to provide an accurate measure of the quantity of water delivered to the facility 20, the valve assembly 10 is structured to prevent air flow from reaching and/or passing through the water meter assembly 26. Such air flow may be in the form of an air pocket or air flow segment which is at least partially separated from the conventional flow water within the supply line 12. Therefore, the facility 20 will only be charged for the actual quantity of water delivered thereto and will not be charged for “air pockets” or “air flow segments” existing within the water supply line 12 due to repair, maintenance, damage, etc. Such air pockets or air flow segments are eliminated or significantly reduced prior to reaching the meter assembly 26 due to the structure and operation of the valve assembly 10, as described in greater detailed hereinafter.

Accordingly, the valve assembly 10 includes a housing 13 structured to be connected to the water supply line 12 such that the interior channel 14 defines at least a part of the path of fluid flow along the water supply line 12 which leads to the meter assembly 26. Further, the housing 13 is appropriately structured to accomplish such “in-line” connection with the water supply line 12 and may include a threaded exterior portion 15. The threaded portion 15 may serve to connect or position the valve assembly 10 immediately adjacent to the meter assembly 26 or in direct connected and fluid communication therewith but upstream thereof.

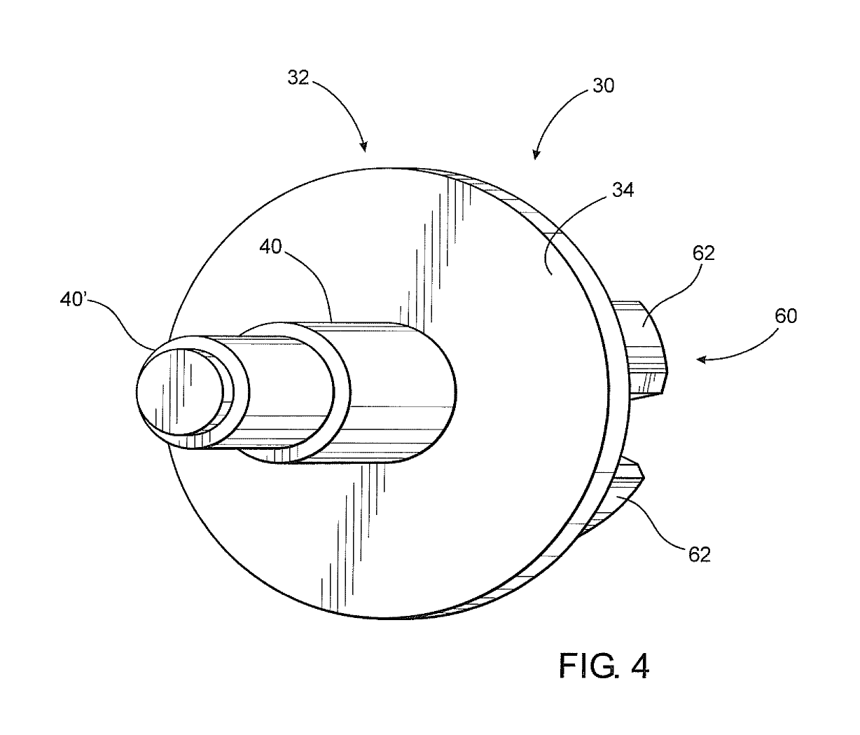

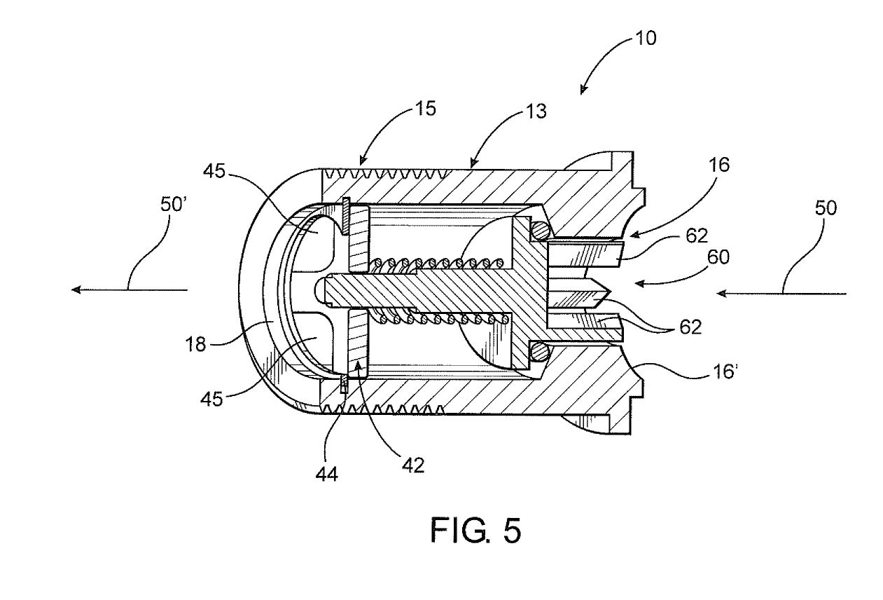

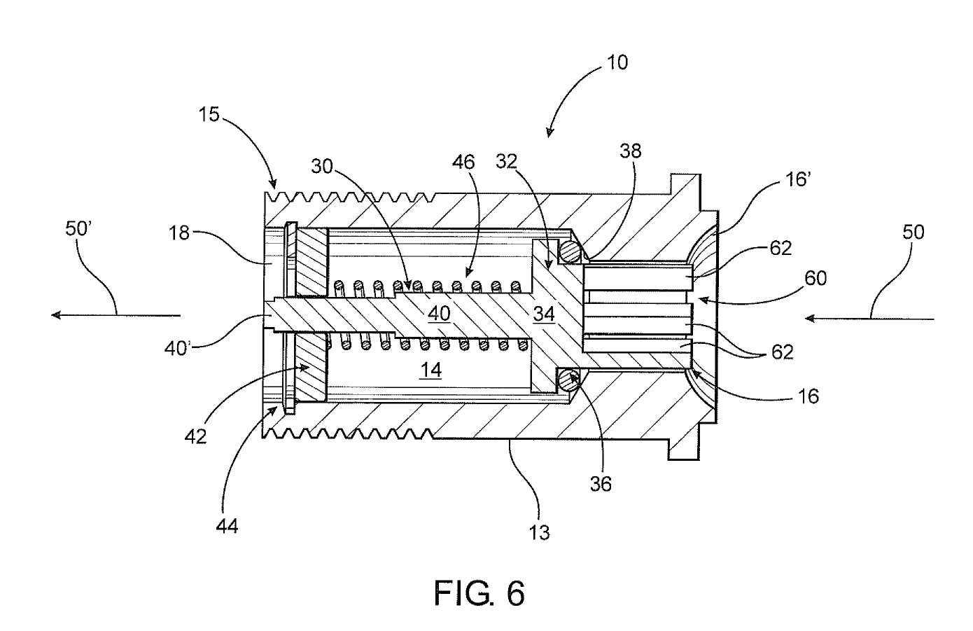

With primary reference to FIG. 3, the body 13 of the valve assembly 10 may also includes a recess or other appropriately configured entrance 16′ disposed immediately adjacent and/or contiguous to the inlet 16 leading to the interior channel 14. In addition, the valve assembly 10 includes a valve body 30, shown in detail in FIG. 4, and represented in an assembled orientation in the embodiments in FIGS. 5 and 6. Accordingly, the valve body 30 is movably disposed within the interior channel 14 of the housing 13 and includes a sealing structure 32 preferably in the form of a stop member 34 disposed into sealing relation to the inlet 16. The sealing structure 32 also includes a seal 36 preferably in the form of an O-ring or other equivalent seal structure which is disposable between the stop member 34 of the sealing structure 32 and interior surfaces 38 adjacent to or directly associated with the inlet 16. Therefore, an accurate description of the sealing structure 32 and in particular the stop member 34 being disposed in sealing relation to the inlet 16 anticipates the seal member 36 being disposed in a sealing position between the exterior surface of the stop member 34 and the surface 38 of the inlet 16. When the seal is in the form of an o-ring it may be mounted in surrounding relation to the stop member 34 as represented.

The valve body 30 also includes an elongated stem or other appropriately configured body portion 40 fixedly or integrally connected to the stop member 34 of the sealing structure 32. Moreover, the length of the body portion 40 preferably extends along at least the majority of the length of the interior channel 14 such that an outer or distal 40′ is supported and/or is movably disposed in cooperative relation to a retaining structure 42. The retaining structure 42 is maintained in its operative position, as represented in FIGS. 5 and 6 by snap ring or like connector 44 disposed within a groove 43. As such, the retaining structure 42 is disposed in retaining relation to a biasing assembly 46 also disposed within the interior channel 14 in direct biasing relation to the stop 34 of the sealing structure 32. Moreover, the biasing assembly 46, which may be in the form of one or more coil springs, is disposed in retaining relation to the retaining structure 42 and in biasing relation to the stop 34 of the seal structure 32. Therefore, the biasing assembly or spring member 46 is normally disposed in biasing relation to the stop 34 so as to exert a “predetermined biasing force” or “predetermined force” thereon which causes it to be disposed into a sealing position defined by a sealing engagement or sealing relation of the sealing structure 32, including the seal 36, relative to the inlet 16.

In addition, the biasing assembly 46 is structured to exert the aforementioned predetermined force on the sealing structure 32 so as to maintain it in its sealing orientation, as represented in FIGS. 5 and 6 unless sufficient water pressure is exerted thereon. Moreover, the predetermined force or predetermined biasing force is sufficient to maintain the sealing structure 32 in the represented sealed orientation relative to inlet 16 until a predetermined water pressure is externally exerted thereon, such as by the normal flow of water through the water supply line 12 as schematically represented by directional arrow 50. As set forth above, the external pressure exerted on sealing on structure 32 by a normal or conventional flow of water reaching the inlet 16 will be sufficient to overcome the “predetermine force” of the biasing assembly 26 thereby forcing the stop 34 to be displaced from its sealing position or orientation as represented in FIGS. 5 and 6.

However, during times of repair, malfunction, maintenance, etc. on or along the water supply line it is common for air pockets or air flow segments to encroach into the path of fluid flow on the interior of the water supply line 12. Typically, the external air pressure exerted on the stop member 32 of the sealing structure 32 when the air pockets or air flow segments reach the inlet 16 is significantly less than the water pressure of the flow of water passing along the water supply line 12 in a conventional fashion. Therefore, this reduced external air pressure of the air pocket or air flow segment, will be insufficient to display the stop 34 of the sealing structure 32 from its sealing relation with the inlet 16, as represented in FIGS. 5 and 6.

It should therefore be apparent that during conventional operation and typical water flow along the water supply line 12, the water pressure will be sufficient to displace and maintain the sealing structure 32 out of the sealing position or orientation as represented in FIGS. 5 and 6. Normal water flow will therefore be allowed to pass into and through the inlet 16 throughout the length of the interior cylinder 14 and out of the housing 13 through the outlet 18. However, an air pocket or air flow segment passing along the water supply line 12 will exert an external pressure on the sealing structure 32 which will be insufficient to displace the sealing structure 32 from its intended sealing relation to the inlet 16. This will result in the compression or disbursement of air pockets within the water supply line 12 and prevent air from reaching the meter 26. The facility 20 will thereby be only be charged for the actual quantity of water delivered thereto along the water supply line 12. Further, the predetermined biasing force exerted on the stop 34 of the sealing structure 32 may be sufficient to effectively compress the air pocket or air flow segment, to the extent that it is dissipated, such as by being compressed into the normal or conventional water flow concurrently passing through the water supply line 12.

Other structural and operative features associated with the one or more preferred embodiments of the valve assembly include an apertured construction of the retaining structure 42. This apertured construction is defined by at least one, but in certain preferred embodiments, a plurality of apertures 45 formed in the retaining structure 42. This apertured construction defined by the one or more apertures 45 allows water to flow through the interior channel 14 and properly exit through the outlet 18 as indicated by directional arrow 50′, by passing through the one or more apertures 45.

Yet additional structural and operative features of the valve assembly 10 in at least one preferred embodiment thereof, include the provision of a stabilizing assembly generally indicated as 60. The stabilizing assembly 60 includes at least one but may also include a plurality of stabilizing members 62 connected to and extending outwardly from the stop member 34 of the sealing structure 32. The plurality of stabilizing members 62 are disposed in spaced relation to one another so as to allow fluid flow there through and facilitate fluid flow through the inlet 16 when the stop member 34 of the sealing structure 32 is displaced out of the sealing position or orientation as represented in FIGS. 5 and 6. However, movement of the stop member 34 into and out of its sealing position or orientation is further facilitated by the one or more stabilizing members 62 being disposed in sliding or otherwise moving engagement with the interior surface 16″ (see FIG. 3) of the inlet 16. This movable or sliding engagement of the stabilizing members 62 relative to the inner the peripheral surface 16″ of the inlet 16 serves to maintain the valve body 30 and in particular the stop 34 of the sealing structure 32 into a preferred, aligned orientation relative to the inlet 16 thereby assuring its proper disposition into the sealing position or orientation of FIGS. 5 and 6.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A valve assembly structured to reduce airflow to a water meter assembly in a water supply line, said valve assembly comprising:
a) a housing structured to be disposed upstream of the water meter assembly in line with the water supply line; flow, and structured to, said disposed along and at least partially defining a path fluid flow in the water supply line upstream of the meter assembly,
b) said housing comprising an interior channel including an inlet and an outlet disposed in fluid communication therewith, said inlet structured to receive all fluid flowing through the water supply line and said outlet structured to pass all fluid from said interior channel back to the water supply line;
c) a valve body movably disposed within said interior channel;
c) said valve body including a sealing structure, said sealing structure moveable within said interior channel between a fluid sealing and an open position so as to regulate a flow of the fluid passing through said interior channel;
d) said sealing structure including a stop member and a seal mounted on said stop member,
e) said seal disposed in substantially surrounding relation to said stop member and positioned between said stop member and a surface of said interior channel so as to prevent fluid passage past said sealing structure when said sealing structure is disposed in said fluid sealing position;
f) a biasing assembly comprising at least one spring disposed and structured to bias said sealing structure into said fluid sealing position;
g) said spring including a predetermined bias structured to maintain said sealing structure in said fluid sealing position until a water flow passing through said inlet and engaging said sealing structure has exerted a predetermined force sufficient to supplanted substantial amounts of air within the fluid at said sealing structure resulting in said fluid pressure exerted on said sealing structure being sufficient to overcome said predetermined bias and move said sealing structure into said open position; and
j) a retaining structure disposed within said interior channel and structured to retain said biasing assembly within said valve body, said retaining structure including at least one aperture structured to facilitate fluid flow through said interior channel to said outlet.

2. A valve assembly as recited in claim 1 wherein said predetermined bias of said spring is 60 psi.

3. A valve assembly as recited in claim 1 wherein said stop member includes a solid surface structured to translate said fluid pressure against said predetermined bias of said spring.

4. A valve assembly as recited in claim 1 further comprising a bypass valve structured to selectively re-route the fluid flow around said valve body and to the water meter assembly.

5. A valve assembly as recited in claim 1 further comprising a stabilizing assembly connected to said sealing structure and movable therewith relative to said housing; said stabilizing assembly disposed and structured to maintain an aligned orientation of said sealing structure with said inlet when disposed into and out of said fluid sealing relation with said inlet.

6. A valve assembly as recited in claim 5 wherein said stabilizing assembly includes at least one stabilizing member connected to an extending outwardly from said sealing structure through said inlet and into movable engagement with an inner peripheral surface of said inlet.

7. A valve assembly as recited in claim 5 wherein said stabilizing assembly includes a plurality of stabilizing members connected to and extending outwardly from said sealing structure through said inlet and into movable engagement with an inner peripheral surface of said inlet.
